(19) United States
(12) Patent Application Publication
(10) Pub. No.: US 2013/0184875 A1
(43) Pub. Date: Jul. 18, 2013

(54) NEED IDENTIFYING DEVICE, AIR-CONDITIONING CONTROLLING SYSTEM, NEED IDENTIFYING METHOD, AND AIR-CONDITIONING CONTROLLING METHOD

(71) Applicant: AZBIL CORPORATION, Tokyo (JP)

(72) Inventor: Mayumi MIURA, Tokyo (JP)

(73) Assignee: AZBIL CORPORATION, Tokyo (JP)

(21) Appl. No.: 13/740,621

(22) Filed: Jan. 14, 2013

(30) Foreign Application Priority Data
Jan. 16, 2012 (JP) 2012-005917

(51) Int. Cl. G05D 23/19

(52) U.S. Cl. CPC G05D 23/19
USPC 700/276

(57) ABSTRACT

An air-conditioning controlling system includes a need identifying device, a control plan storage device that stores, respectively for a temporary need and a persistent need, control plans that establish rules for changing a control setting value for air-conditioning in response to a need relating to air-conditioning from an informant, a control plan determining device that determines a control plan corresponding to an identification result of the need identifying device, as a control plan to be applied to an air-conditioning equipment, and an equipment controlling device that controls the air-conditioning equipment based on the determined control plan. The need identifying device includes an inputting unit that receives the need from the informant, and a need identifying unit that identifies whether the need is the temporary need or the persistent need, based on information pertaining to an activity that changes a metabolic rate of the informant.

### CROSS-REFERENCE TO RELATED APPLICATION

The present application claims priority to Japanese Patent Application No. 2012-005917 filed Jan. 16, 2012, the entire content of which being hereby incorporated herein by reference.

### FIELD OF TECHNOLOGY

The present invention relates to a need identifying device and need identifying method for identifying whether a need regarding air-conditioning from an informant is a temporary need or a persistent need, and relates to an air-conditioning controlling system and air-conditioning controlling method for applying the identification result to the air-conditioning control.

### BACKGROUND

In buildings wherein air-conditioning controlling systems are deployed, usually reporting of needs by occupants regarding air-conditioning (for example, “Hot,” “Cold,” “Increase the room temperature by XX° C.,” “Decrease the room temperature by XX° C.,” and the like) is typically a troublesome task regardless of the reason why the occupant is present (for example, for office work by the occupant in the case of an office). Moreover, for needs (hereinafter termed “weak needs”) in a situation wherein the occupant is not strongly aware of his or her thermal discomfort (a situation wherein the occupant is comfortable or somewhat warm or somewhat cold), the occupant will not be strongly aware of that feeling, and thus no need report is performed. As a result, the need reports tend to be primarily for those needs (hereinafter termed “strong needs”) that are relatively strong when compared to the “weak needs.”

As a result, if, for example, the temperature setting value were to be decreased excessively as the result of the air-conditioning control responding to a strong need of an occupant in terms of “Hot,” then even if the room environment was improved to a suitable state that was neither hot nor cold during the process, there would be a tendency for there to be no report of a “weak need” of “Neither hot nor cold.” Because a “weak need,” which indicates an environment that is near to the appropriate state, tends to not be reported by an occupant, the room temperature setting value is maintained until, eventually, the opposing “strong need” is evoked. For example, even if the room temperature setting value is reduced too far in response to a need report of “Hot,” because there is no need report of “Somewhat hot” or “Somewhat cold,” the room temperature setting value will be maintained as-is. The result is that the temperature of the room will be reduced until the opposing “Cold” “strong need” is reported.

Moreover, when a “Cold” need is reported, there is the possibility that the room temperature setting value will be increased too much, resulting in the room temperature being raised to the extent that the opposing “Hot” “strong need” will be reported. The repetitive iteration of these opposing “strong needs”, in the worst-case scenario, will cause the occupant to cyclically feel the opposing sensations of “Hot” and “Cold.” This type of iteration is not only uncomfortable for the occupant and troublesome, but also made result in wasted energy through destabilization of control.

Given this, there has been a proposal for a reporting-type air-conditioning system wherein the occupants themselves directly report their needs regarding air-conditioning and the number of reports are tabulated periodically, provided with: an individual report cancelling portion for canceling a report when a specific effective time has elapsed since the report was inputted; a remaining time displaying portion for displaying how much of the effective time is remaining, enabling the informant to check how much of the effective time is remaining; and a notifying portion for prompting the informant to report again. See, for example, Japanese Patent No. 4604630.

In the reporting-type air-conditioning controlling system disclosed in, for example, Japanese Patent No. 4604630, there is no change to the fact that there is a tendency for “weak needs” to not be reported, resulting in a tendency to add up the “strong needs,” and thus there is a problem in that control tends to become destabilized.

Moreover, the effective time setting is effective in a case wherein the experience of the informant improves uniformly in the direction of comfort with the passage of time. However, in practice, often, such as in cases wherein the magnitude of the decrease in the temperature setting value in response to a need report of “Hot” is inadequate, the need continues to exist, rather than being resolved. When the effective time setting is used in such a case, the informant, for whom the need has not been resolved, will have to report the same need again each time a report is canceled. In the worst case, the occupant will be forced to choose between either going through the trouble of performing the reporting task at regular intervals, or to endure an unsatisfactory environment, which tends to increase the dissatisfaction of the occupant with the air-conditioning controlling system. Consequently, the effective time setting does not ameliorate the destabilization of control due to the tendency to not report the “weak needs.”

### SUMMARY OF THE INVENTION

The present invention was created in order to solve the problem set forth above, and thus the present invention provides, among others, a need identifying device, an air-conditioning controlling system, a need identifying method, and an air-conditioning controlling method, able to, for example, reduce the likelihood of destabilization of control while reducing the burden of need reporting (frequency and work) on behalf of the informants.

A need identifying device according to an aspect of the present invention includes an inputting unit that receives a need pertaining to air-conditioning from an informant, and a need identifying unit that identifies whether the need from the informant is a temporary need or a persistent need, based on information pertaining to an activity that changes a metabolic rate of the informant.

Furthermore, in an example structure of the need identifying device according to the aspect of the present invention, the need identifying unit includes an identification rule storage unit that stores an identification rule derived in advance from information pertaining to activities that change the metabolic rate of the informant, and an identification processing unit that identifies whether the need from the informant is the temporary need or the persistent need, based on a time at which the need from the informant was produced and based on the identification rule.

Furthermore, in another example structure of a need identifying device according to the aspect of the present invention, the need identifying unit further includes an identification rule deriving unit that derives the identification rule from the information pertaining to the activity that changes the metabolic rate of the informant and from a specific setting rule.

Furthermore, in yet another example structure of the need identifying device according to the aspect of the present invention, the information pertaining to the activity that changes the metabolic rate of the informant is a schedule pertaining to the informant.

Furthermore, in yet still another example structure of the need identifying device according to the aspect of the present invention, the information pertaining to the activity that changes the metabolic rate of the informant is a workplace schedule for a workplace to which the informant belongs.

Furthermore, in a further example structure of the need identifying device according to the aspect of the present invention, the information pertaining to the activity that changes the metabolic rate of the informant is a personal schedule.

Furthermore, in yet a further example structure of the need identifying device according to the aspect of the present invention, the information pertaining to the activity that changes the metabolic rate of the informant is a workplace schedule for a workplace to which the informant belongs and a personal schedule of the informant.

Furthermore, in yet still a further example structure of the need identifying device according to the aspect of the present invention, the need identifying unit performs identification periodically using only a representative need, based on a plurality of needs produced during a period of a constant length.

An air-conditioning controlling system according to another aspect of the present invention includes the need identifying device, a control plan storage device that stores, in advance, respectively for temporary needs and for persistent needs, control plans wherein rules for changing control setting values for air-conditioning in accordance with needs from the informant are established, a control plan determining device for determining, from the control plans stored in the control plan storage device, a control plan corresponding to an identification result of the need identifying device, and being applied to an air-conditioning equipment, and an equipment controlling device that controls the air-conditioning equipment based on the control plan determined by the control plan determining device.

Furthermore, in an example structure of the air-conditioning controlling system according to the present invention, the control plan corresponding to the temporary need is a control plan that establishes that a control setting value is changed in accordance with the need from the informant, and that the control setting value is returned to a value from prior to the change, after a specific sustaining time has elapsed, and the control plan corresponding to the persistent need is a control plan that establishes that the control setting value is changed on a persistent basis in accordance with the need from the informant.

Furthermore, in another example structure of the air-conditioning controlling system according to the another aspect of the present invention, the control plan determining device determines a control plan specifying, from a plurality of air-conditioning equipments, an air-conditioning equipment that is to be subjected to control, based on target-equipment specifying information added to the need from the informant, and the equipment controlling device controls the air-conditioning equipment that is to be subjected to control based on the control plan determined by the control plan determining device.

Furthermore, in yet another example structure of the air-conditioning controlling system according to the present invention, when there is a competition between the temporary need and the persistent need, the control plan determining device follows a policy that has been established in advance to use either the temporary need or the persistent need, and apply, to the air-conditioning equipment, the control plan corresponding to the need that is used.

A need identifying method according to yet another aspect of the present invention includes an inputting step for receiving, from an informant, a need pertaining to air-conditioning, and a need identifying step for identifying whether the need from the informant is a temporary need or a persistent need, based on information pertaining to an activity that changes a metabolic rate of the informant.

An air-conditioning controlling method according to yet still another aspect of the present invention includes the aforementioned steps in the need identifying method, a control plan determining step for determining, from control plans stored in a control plan storage device, a control plan corresponding to an identification result of the need identifying step, as a control plan to be applied to an air-conditioning equipment by referencing the control plan storage device that stores, in advance, respectively for temporary needs and for persistent needs, the control plans wherein rules for changing control setting values for air-conditioning in accordance with the need from the informant are established, and an equipment controlling step for controlling the air-conditioning equipment based on the control plan determined by the control plan determining step.

The present invention enables, for example, the identification of the need from the informant as being of the persistent type, focusing on the time of persistence, through the provision of the need identifying unit that identifies whether the need from the informant is the temporary need or the persistent need, based on the information pertaining to the activities that change the metabolic rate of the informant. Consequently, the application of the identification result to air-conditioning control enables, for example, a reduction in the likelihood of destabilization of the air-conditioning control while reducing the burden on the informant.

Moreover, in the present invention, the use of the workplace schedule of the workplace to whom the informant belongs, and of the personal schedule of the informant, as the information pertaining to the activities that can change the metabolic rate of the informant, enables, for example, inference regarding needs and informant activities, enabling an increase in the reliability of the need identification without a measurement of the metabolic rate and without prompting the informant to input new information to be used in identification. Moreover, in the present invention, the use of the workplace schedule or the personal schedule of the informant enables, for example, a facilities manager or energy manager to create a system wherein forecasting in management is easy, taking the metabolic rate into account.

Moreover, the present invention, through identification using only a representative need, of a plurality of the needs, that arises at fixed intervals, is compatible with, for example, control that responds to the needs from the informants on a periodic basis.

Moreover, the present invention, through determining, as the control plan that is to be applied to the air-conditioning equipment, from among the control plans that are stored in the control plan storage device, a control plan corresponding to the identification result by the need identifying device, and by then controlling the air-conditioning equipment based on the control plan that has been determined, is able to, for example, apply the dedication result by the need identifying device to the air-conditioning control.

The present invention, through specifying, based on target-equipment specifying information added to the need from the informant, the air-conditioning equipment that is to be subject to control, from among a plurality of air-conditioning equipments, and through determining a control plan, to control, based on the determined control plan, the air-conditioning equipment that is subject to control, enables, for example, compatibility with a case wherein the air-conditioning controlling system controls a plurality of air-conditioning equipments.

### BRIEF DESCRIPTION OF THE DRAWINGS

FIG. 1 is a diagram illustrating an example of an air-conditioning controlling system.

FIG. 2 is a diagram illustrating the relationship between the metabolic rate of an occupant and PMV.

FIG. 3 is a block diagram illustrating a structure of a need identification-type air-conditioning controlling device according to an example according to the present invention.

FIG. 4 is a block diagram illustrating the structure of a need identifying device according to the example according to the present invention.

FIG. 5 is a flowchart for explaining the operation of the need identification-type air-conditioning controlling device according to the example according to the present invention.

FIG. 6 is a diagram illustrating an example of a workplace schedule.

FIG. 7 is a diagram illustrating examples of time bands wherein a reported need is viewed as a temporary need.

FIG. 8 is a diagram illustrating an example of a temporary need identification table according to the example according to the present invention.

FIG. 9 is a diagram for explaining a control plan according to the example according to the present invention.

FIG. 10 is a diagram illustrating an example of changing control setting values in response to a reported need, according to the example according to the present invention.

FIG. 11 is a block diagram illustrating a structure of a need identification-type air-conditioning controlling device according to another example according to the present invention.

FIG. 12 is a diagram illustrating an example of a personal schedule.

FIG. 13 is a diagram illustrating an example of setting rules for temporary need identifying time bands.

FIG. 14 is a diagram illustrating an example of a temporary need identification table according to the another example according to the present invention.

FIG. 15 is a diagram illustrating examples of time bands wherein a reported need is viewed as a temporary need.

FIG. 16 is a diagram illustrating an alternate example a control setting value controlling device in response to a reported need, according to the another example according to the present invention.

### DETAILED DESCRIPTION

The present invention applies to a method and device for controlling air-conditioning of a type that adapts to needs, for applying needs of occupants regarding air-conditioning, and is not limited to cases wherein a reporting-type air-conditioning controlling system, wherein occupants input needs directly into the air-conditioning controlling system, is used. That is, the present invention applies to both the case wherein (A) wherein a need is received from an occupant and the facilities manager uses a Building and Energy Management System (BEMS), or the like, to apply the occupant need in the air-conditioning control and also (B) the case wherein the occupants themselves report their needs regarding air-conditioning directly to the air-conditioning controlling system (including also cases wherein the occupant needs are received remotely by an Application Service Provider (ASP) service, or the like, to be applied in the control).

In the explanation of the present invention, the following distinctions are drawn between “occupants,” “informants,” and “need inputters.” In the present invention, individuals who reside in the air-conditioning environment that is subject to control are called “occupants.” Whether or not a reporting action occurs depends on the occupants. Moreover, in the present invention occupants who initiate an activity to report the need for a change in air-conditioning (including those who do so via voice notification using a telephone, or the like), are known as “informants.” Regardless of whether or not an occupant feels dissatisfaction regarding the air-conditioning environment, if no reporting activity is initiated, he or she will not be treated as an “informant.” Moreover, in the present invention, an individual who inputs, into the air-conditioning controlling system, a need by an occupant for a change in the air-conditioning, for the purposes of applying it in the air-conditioning control, are “need inputters.” When a reporting-type air-conditioning controlling system wherein the occupants input needs for changes directly into the air-conditioning controlling system, then the informants and the need inputters are identical. Moreover, in other air-conditioning controlling systems, there are systems wherein the informants report needs for changes (providing notification through telephone, email, or the like), to facilities managers who are the need inputters, and the facilities managers input those needs into the air-conditioning controlling system.

The inventor has focused on the fact that, in air-conditioning controlling systems such as set forth above, control that is different from that for normal need reports is appropriate for temporary (in contradistinction to “persistent”) need reports.

A need that that is reported for an air conditioner, as typically occurs within an office, often is due to an increased metabolic rate due to physical activity (after arriving at work, after returning from work, after moving to a conference room, or the like) or due to eating (lunch, or the like). However, because such needs tend to be on the side that resolve themselves with the passage of time, even if there is no change in the room environment, they tend to evoke a destabilized state a destabilized state more that would needs that arise due to an unsuitable ambient environment. For example, according to Takuya TAIRA, et al., “A Comparison of Changes in Postprandial Energy Expenditure at Breakfast, Lunch, and Supper Using a Human Calorimeter” (Journal of Nutrition, Vol. 68, No. 6, Pgs. 373-377, 2010), the meal-induced generation of heat falls to a stable state after between about 30 and 40 minutes. Consequently, the application of adaptive control reflecting these characteristics regarding temporary needs can reduce the likelihood of destabilization of control.

Moreover, the inventor focuses on the use of the schedule information that is commonly managed in a typical office when identifying a temporary need. By comparing, to the schedule information, the timing of reports of needs, it is possible to make inferences regarding needs and informant activities, making it possible to increase the certainty of a temporary need identification without performing a metabolic rate measurement and without prompting the informant to input new information to be used in the identification. Moreover, referencing “recorded schedule information” produces a method by which facilities managers and energy managers can take metabolic rates into account, wherein forecasting and control is easy.

### EXAMPLE

Examples for carrying out the present invention will be explained below in reference to the figures. In an example, identification of whether or not a need is a temporary need is made, based on identification rules derived in advance, from the workplace schedule and on the timing with which the need is reported, and the air-conditioning controlling plan is determined based on the identification result. Here the “controlling plan” refers to the establishment of rules for changing the control setting values for the air-conditioning in response to needs.

In the example, an explanation will be given for an example of an occupant reporting-type air-conditioning controlling system wherein the occupants themselves input their own needs into the system. In the present invention, the critical point is that of identification of changing needs of informants relative to air-conditioning focusing on persistence time (hereinafter termed “persistence classification”), to be applied to air-conditioning control. In the present invention, appropriate design changes are possible through the ordinary engineering knowledge of one skilled in the art, regardless of the air-conditioning method (for example, discrete versus central, and so forth), the type of air-conditioning equipment used, the element controlled by air-conditioning (temperature, humidity, dissipation, or compound control thereof, or the like), and regardless of the type of terminals for inputting needs (BEMS, PCs, mobile telephones, smart phones, dedicated input terminals, and so forth), and the like.

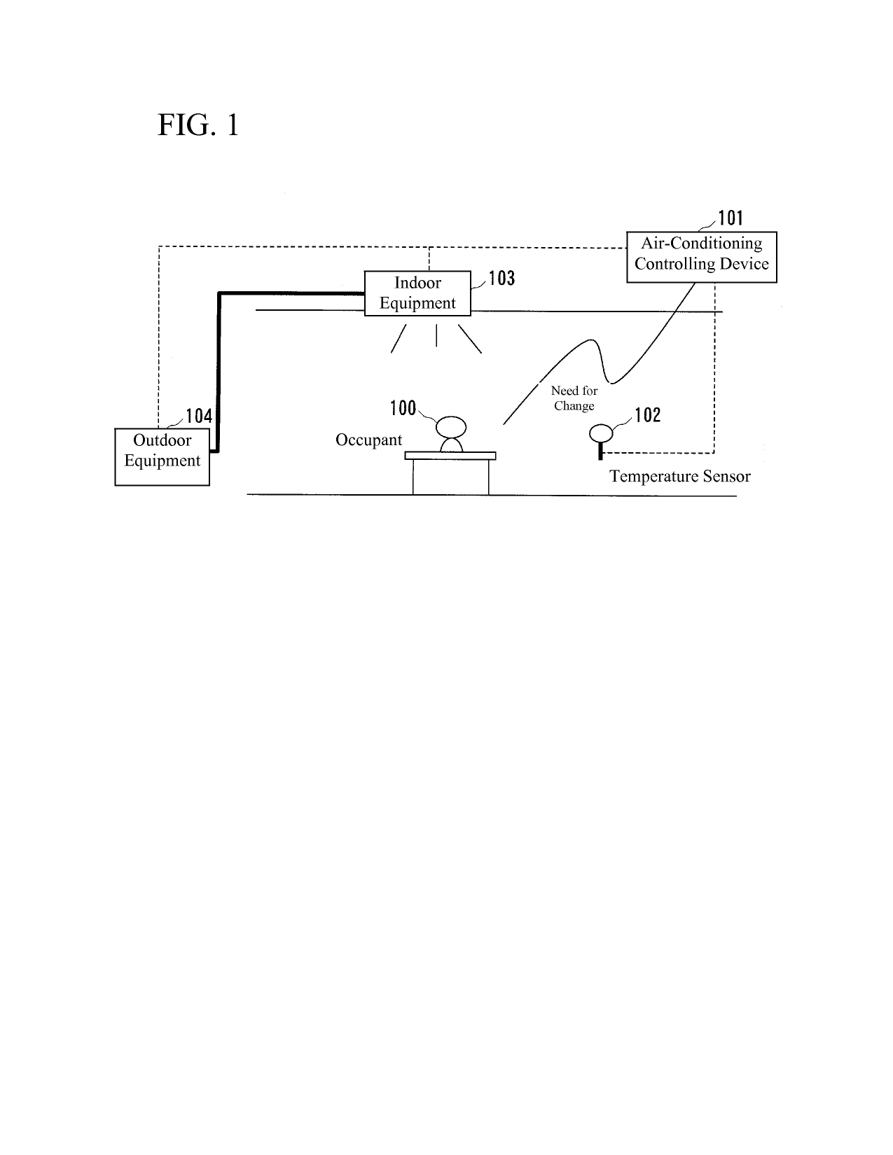

For simplicity in description, the example will explain a case of an occupant reporting-type air-conditioning controlling system wherein a single occupant is present in a single applicable air-conditioned area (FIG. 1). In FIG. 1, 100 is the occupant, 101 is an air-conditioning controlling device (a controller) for receiving a change need, 102 is a temperature sensor for measuring the temperature of the air-conditioned area, 103 is indoor equipment, and 104 is outdoor equipment. The air-conditioning controlling device 101 controls the air-conditioning equipment (the indoor equipment 103 and the outdoor equipment 104) to cause the room temperature, measured by the temperature sensor 102, to match a room temperature setting value. Moreover, while an example of cooling in the summertime will be explained in the example, obviously the present invention can be applied also to heating in intermediate seasons and in the winter.

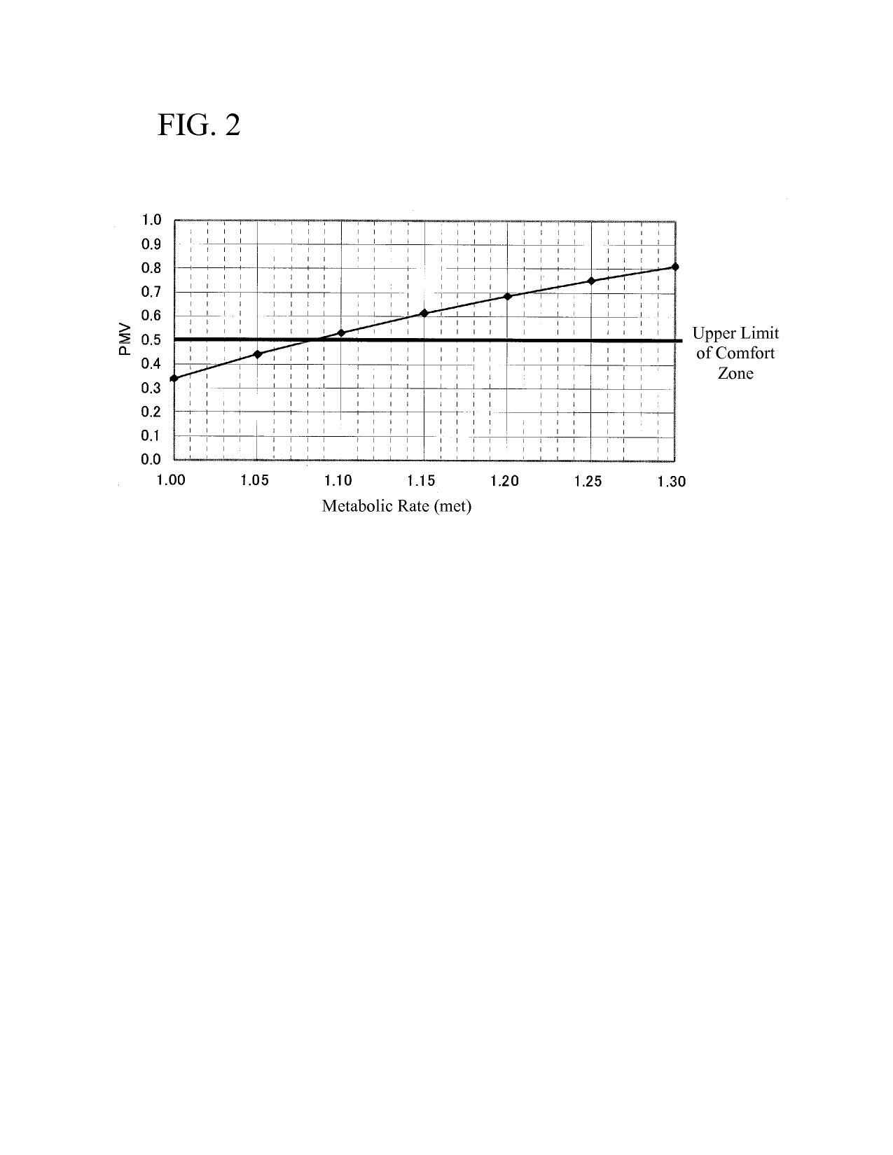

FIG. 2 shows the relationship between the metabolic rate of the occupant and the Predicted Mean Vote (PMV), which is an indicator of the perception of being hot or cold, expressing the comfort of the air-conditioned area. In the example in FIG. 2, factors other than the metabolic rate of the occupant that affect the PMV (temperature, humidity, dissipation, air flow, and amount of clothing) are assumed to be constant values, envisioning an office in the summertime. Specifically, the dissipation temperature is defined as 27° C., the air flow is defined as 0.1 m/s, the relative humidity is defined as 50%, and the amount of clothing is defined as 0.5 (clo).

As an energy/electricity saving strategy, there is a tendency for room temperature setting values for air-conditioning to be set in a direction that produces an adverse effect on the indoor environment, based on the values recommended by the Ministry of the Environment (28° C. in the summertime and 20° C. in the wintertime). However, because room temperature is not the only factor that affects comfort, adverse changes in the other factors will cause a deviation from the ±0.5 range that is the PMV comfort zone. In the example in FIG. 2, a case is illustrated wherein the temperature is set 1° C. toward the comfortable side (27° C.) from the value recommended by the Ministry of the Environment, but when, for example, the metabolic rate of the occupant is increased by 10% for 1.1 [met] from the standard metabolic rate of 1.0 [met] through eating, the PMV can be seen to exceed the 0.5 that is the upper limit for the comfort zone, which can be understood to potentially become a cause giving rise to a need report after eating.

However, because a need that is produced through eating (such as lunch) or through physical activity (after arriving at work, after returning from work, after moving to a conference room, or the like) is due to a temporary increase in the metabolic rate, if the metabolic rate falls and stabilizes with the passage of time, then there will eventually be movement in the direction of resolution, even if there is no change in the room environment. Specifically, even if one feels too hot immediately after returning to the office after being out, as time elapses directly after returning to the office, this perception of being hot may resolve itself notwithstanding there being no change in the room environment, such as in the temperature, humidity, or the like. On the other hand, an occupant who is continuously working in the office will have a metabolic rate that is in a steady-state, so the factor that triggers a need will usually be the room environment, rather than a change in the environment within the body on the occupant side. In such a case, there is a high likelihood that the need will persist unless there is an appropriate change to the room environment in response to the need reported by the occupant.

In this way, in addition to change need classifications (hereinafter termed “change classifications”) wherein the direction of the change in the air-conditioning (warmer vs. cooler) and the intensity are related in the need report, such as in “Hot,” “Somewhat hot,” “Neither hot nor cold,” “Somewhat cold,” “Cold,” “Increase by XX° C.,” “Decrease by XX° C.,” and the like, there are also categories that focus on the persistence (hereinafter termed “persistence categories”), such as needs that will eventually move in the direction of resolution even in the absence of change in the room environment (hereinafter termed “temporary needs”) vs. needs with a high likelihood of persisting if there is no change in the room environment (hereinafter termed “persistent needs”).

In particular, needs that result from a sudden increase in metabolic rate due to eating, or the like, tend to be temporary, strong needs, and sometimes result in multiple repeated reports of strong needs in a short period of time. However, because the perception itself of the need will move in the direction of resolution with the passage of time, if one were to focus only on the change category, without differentiating from persistent needs, to apply the same type of control, then there will be a tendency for the temporary needs to trigger destabilization of control, as described above. Because of this, a temporary need is identified and a control plan that differs from that used for a persistent need is applied in order to reduce the likelihood of destabilization of control.

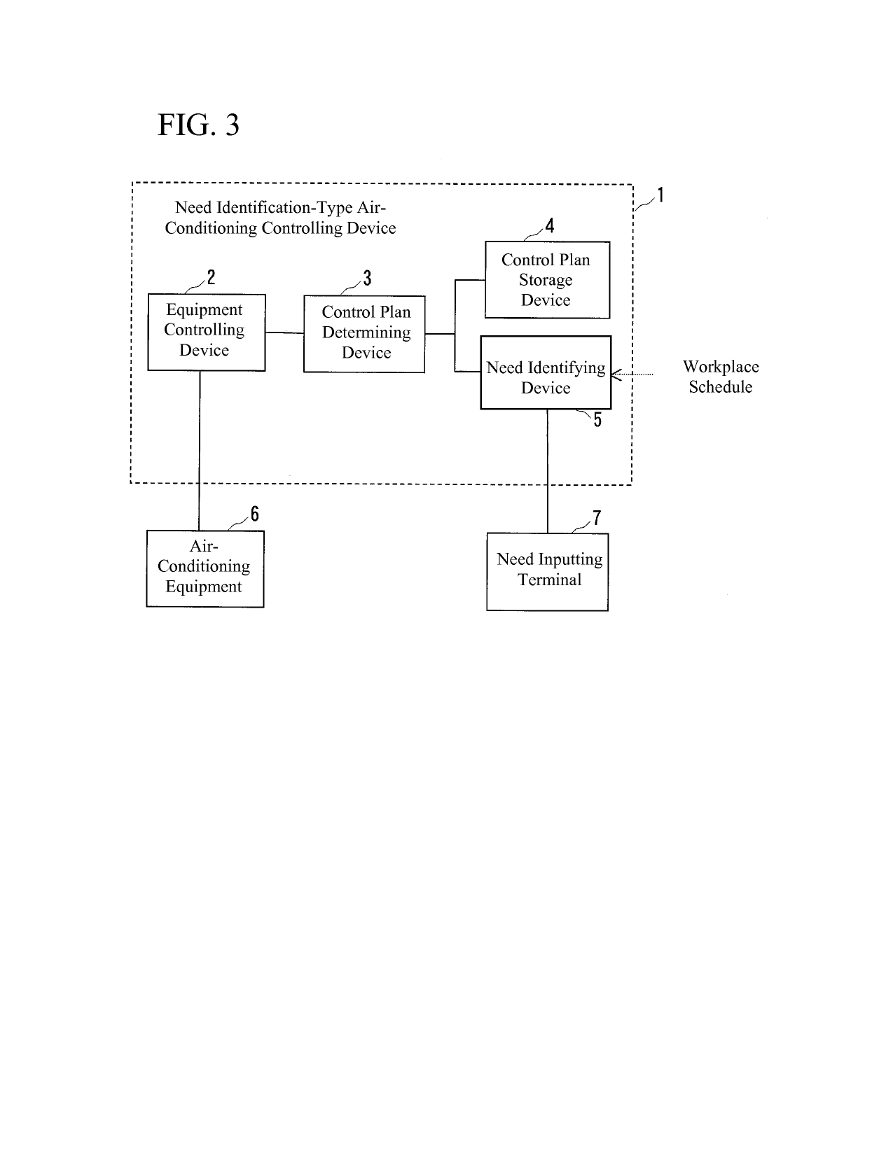

FIG. 3 is a block diagram illustrating the structure of a need identification-type air-conditioning controlling device according to the example. The need identification-type air-conditioning controlling device 1 is provided with an equipment controlling device 2, a control plan determining device 3, a control plan storage device 4, and a need identifying device 5.

The equipment controlling device 2 controls air-conditioning equipment 6 based on the control plan established by the control plan determining device 3.

The control plan determining device 3 determines, from among the control plans that are stored in the control plan storage device 4, the control plan to be applied to the air-conditioning equipment 6 based on the control plan that is in effect at the point in time of processing a need and based on the identification result by the need identifying device 5.

Control plans that are to be applied in response to the identification results by the need identifying device 5 are set up in advance and stored in the control plan storage device 4. These control plans are set up in advance by a control contractor or the facilities manager.

Temporary need identification rules that use the workplace schedule are set up in advance and stored in the need identifying device 5. The temporary need identification rules are set up in advance by the control contractor, the facilities manager, or the energy manager. The need identifying device 5 identifies the persistence category of a reported need based on the identification rules.

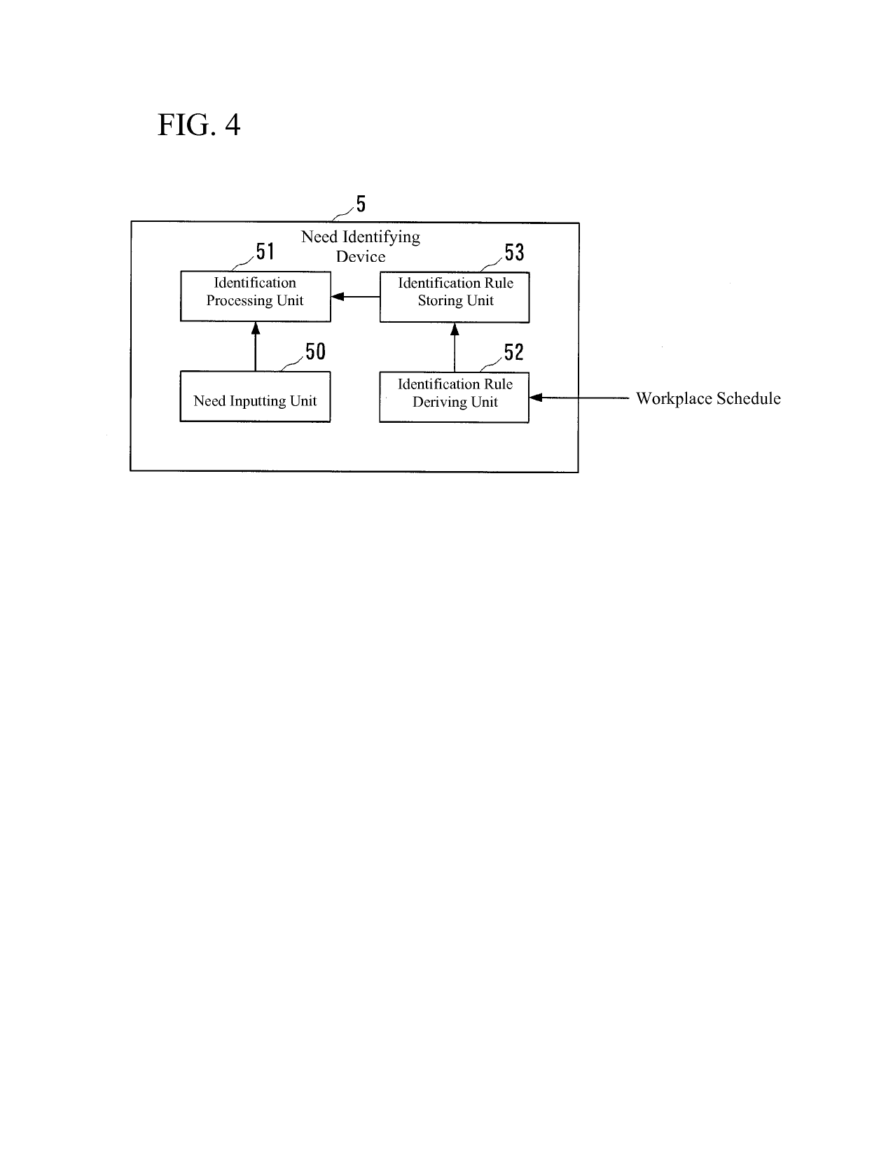

FIG. 4 is a block diagram illustrating the structure of the need identifying device 5. The need identifying device 5 is structured from a need inputting unit 50 for receiving a need that is inputted from a need inputting terminal 7, an identification processing unit 51 for identifying the persistence category of the need, an identification rule deriving unit 52 for deriving identification rules, and an identification rule storage unit 53 for storing the identification rule.

The need inputting terminal 7 may be a PC, a mobile telephone, a smart phone, a dedicated remote control terminal, or the like.

Note that although the need identification-type air-conditioning controlling device 1 is provided within the air-conditioning controlling device 101 illustrated in FIG. 1, the need identifying device 5 may be provided outside of the air-conditioning controlling device 101.

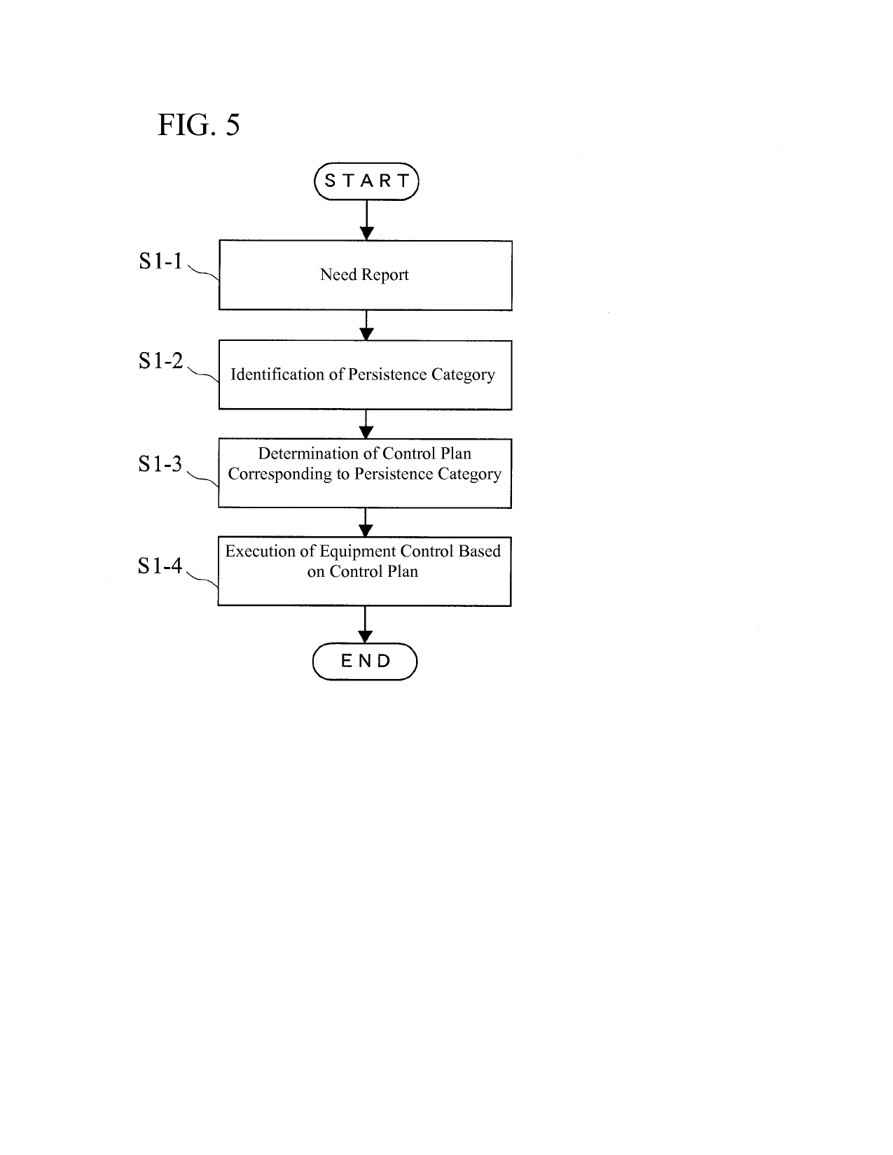

The operation of the air-conditioning controlling system of the example will be explained next. FIG. 5 is a flowchart for explaining the operation of the need identification-type air-conditioning controlling device 1 when an occupant need report has been received from a need inputting terminal 7.

The need inputting terminal 7 sends, to the need identifying device 5, the change category DS of the need inputted by the need inputter and the report timing Stime thereof, and the need inputting unit 50 of the need identifying device 5 stores, as a need V(DS, Stime), the information that has been received (Step S1-1 in FIG. 5). For simplicity, in the example, it is assumed that there are only two possible change categories DS that can be selected by the user, “Hot” and “Cold,” where “Hot” is indicated by the value “1,” and “Cold” is indicated by the value “−1.”

That is, a need reported by the occupant as “Hot” with a report time of 10:10 AM would be stored as V(1, 10:10), and a need reported as “Cold” at that same time would be stored as V(−1, 10:10). Note that while in this example the change category DS and the report time Stime are both sent from the need inputting terminal 7, the report time Stime need not necessarily be sent from the need inputting terminal 7, but instead the report time Stime may be added by the need inputting unit 50 using, for the report time, the time at which the need report is received.

When a need V(DS, Stime) is received from the need inputting terminal 7, the identification processing unit 51 of the need identifying device 5 performs identification of the persistence category of the reported need based on the temporary need identification rules established in advance in the identification rule storage unit 53 (Step S1-2 in FIG. 5). While the explanation in the example is for a case of identifying the persistence category of the reported need using a temporary need identification table that is stored in the identification rule storage unit 53, of course, mathematical formulas may be used instead of a temporary need identification table, and there is no limitation to using a table.

The identification rules, such as the temporary need an indication table, may be set up by the control contractor, the facilities manager, or the energy manager, or may instead be derived by the identification rule deriving unit 52. In the example, they are set up by the control contractor, facilities manager, or energy manager. The details of the method for deriving a temporary need identification table by the identification rule deriving unit 52 will be explained in detail in another example.

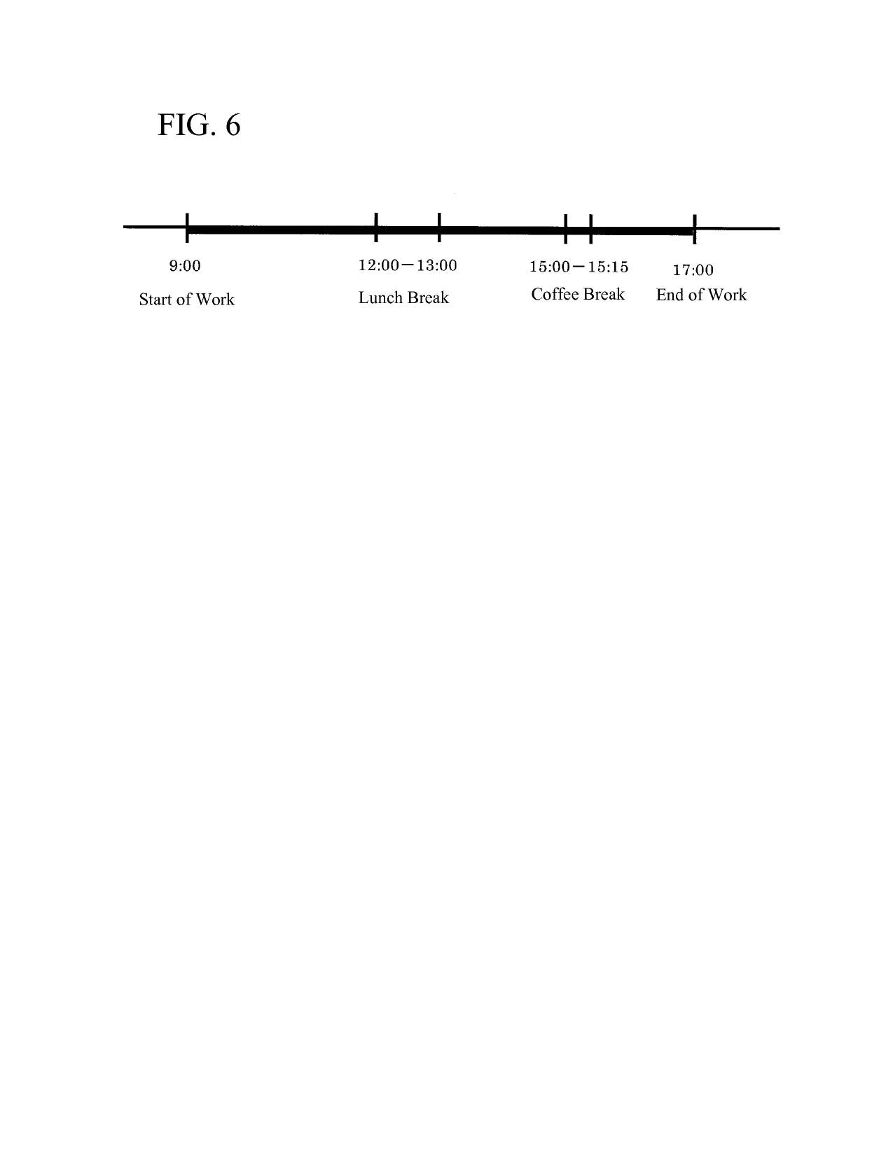

FIG. 6 shows an example of a workplace schedule. In the example in FIG. 6, work hours are from 9:00 AM to 5:00 PM. There is a lunch break from 12:00 noon to 1:00 PM, and a coffee break from 3:00 PM to 3:15 PM.

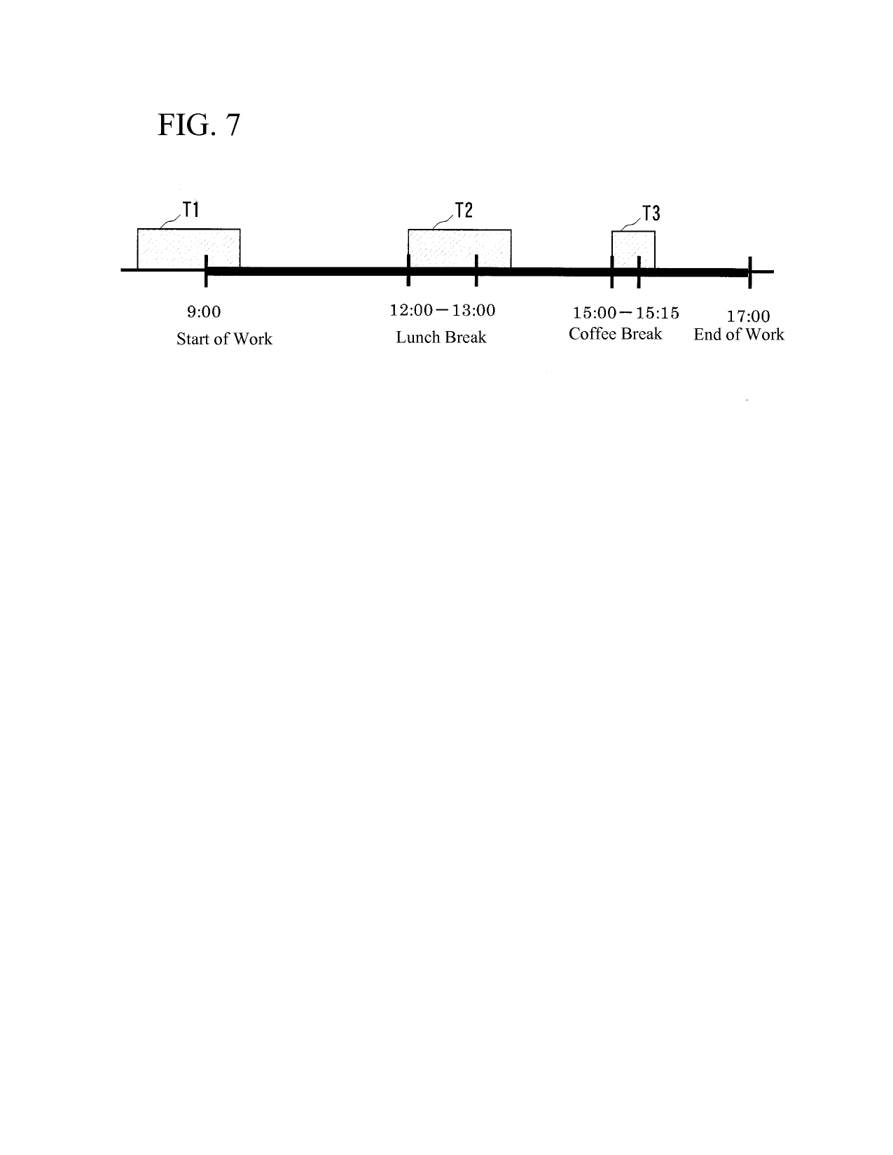

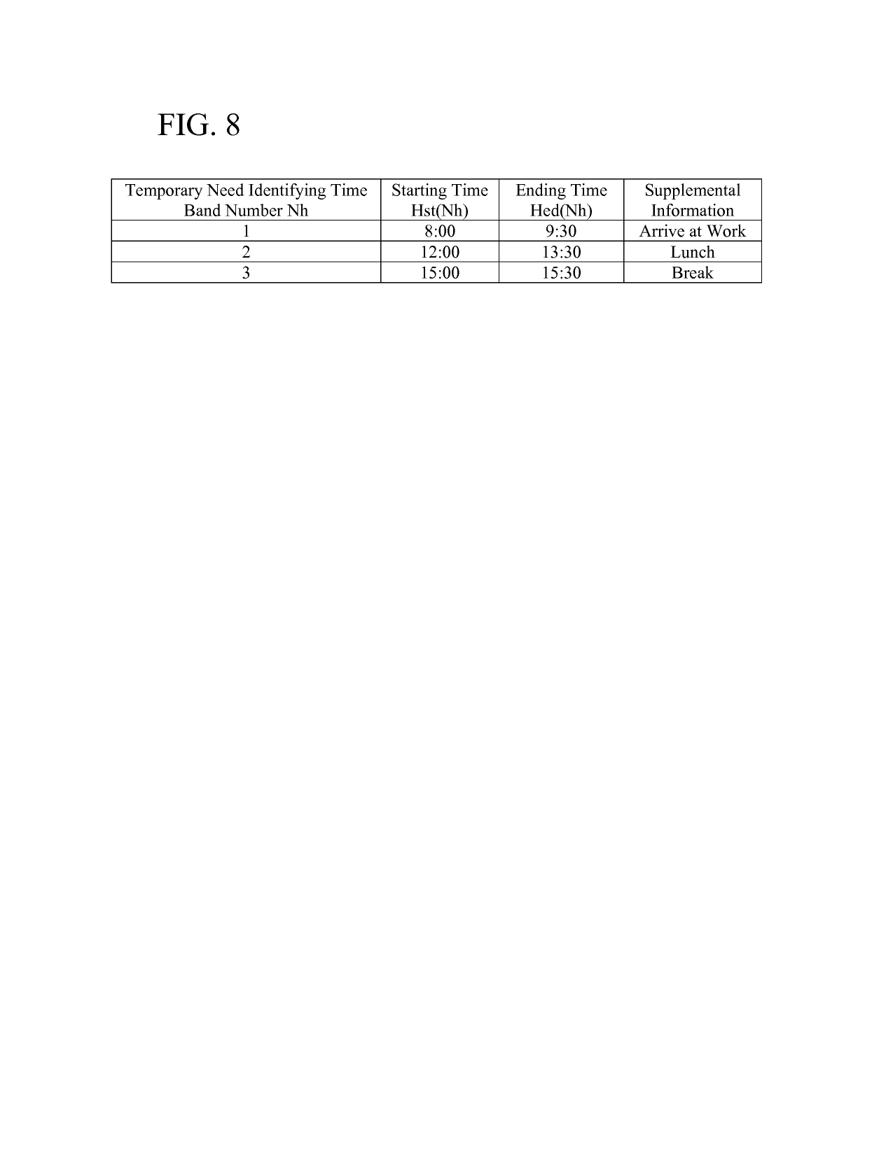

FIG. 7 is a diagram illustrating examples of time bands for the need identifying device 5 to identify, as temporary needs, reported needs that have been received, and FIG. 8 is a diagram illustrating an example of a temporary need identification table provided in the identification rule storage unit 53. In the example in FIG. 7, there are three time bands T1 through T3 for recognizing reported needs as temporary needs, where time band T1 is the interval from 8:00 AM to 9:30 AM, time band T2 is the interval from 12:00 noon to 1:30 PM, and time band T3 is the interval from 3:00 PM to 3:30 PM. These temporary need identifying time bands T1, T2, and T3 are identified by time band numbers Nh, and are assigned, respectively, Nh=1, 2, and 3.

As illustrated in FIG. 8, the temporary need identification table stores, in association with each other, temporary need identifying time band numbers Nh, temporary need identifying time band starting times Hst(Nh), temporary need identifying time band ending times Hed(Nh), and supplemental information. As described above, the details thereof are established primarily by the control contractor, the facilities manager, and the energy manager. Note that the supplemental information is provided for the explanation in the example, and is not used in the need identifying operation. The three time bands T1 through T3 with the time band numbers Nh=1, 2, and 3 are set up based on the workplace schedule illustrated in FIG. 6, corresponding to the occupant activities of “Arrival at work,” “Lunch,” and “Break,” indicated by the supplemental information in the example table in FIG. 8. These time bands can be adjusted as appropriate to match the actual operations.

If a report time Stime for a need V(DS, Stime), received from the need inputting terminal 7, is included in any of the three time bands T1 through T3 with the time band numbers Nh=1, 2, and 3, then the identification processing unit 51 of the need identifying device 5 identifies the persistence category of that need V(DS, Stime) as “Temporary.” That is, when a report time Stime of a need V(DS, Stime) fulfills the conditions in Expression (1), below, then the identification processing unit 51 sets the persistence category identification flag Ftmp (hereinafter termed the “identification flag”), which indicates the persistence category of the need V(DS, Stime), to Ftmp=1, and if the conditions of Expression (1) are not fulfilled, sets the identification flag Ftmp to Ftmp=0.

Hst(x)≦Stime≦Hed(x) (1)

In Expression (1), Hst(x) is the starting time for the temporary need identifying time band with the time band number x, and Hed(x) is the ending time for the temporary need identifying time band with the same time band number x. An identification flag Ftmp=1 indicates that the need V(DS, Stime) is a temporary need, and the identification flag Ftmp=0 indicates that the need V(DS, Stime) is a persistent need.

In the example, when the report time Stime satisfies the conditions in Expression (1) that are specified by the starting and ending times for the time bands that are recorded in the temporary need identifying table, specifically, when it satisfies any of the conditions of 8:00≦Stime≦9:30, 12:00≦Stime≦13:30, 15:00≦Stime≦15:30, then the identification flag Ftmp is set to 1, and if none of the conditions is satisfied, then the identification flag Ftmp is cleared to 0.

The identification processing unit 51 associates a need change category DS and an identification flag Ftmp with the need V(DS, Stime) that has been received from the need inputting terminal 7, and stores these as a need status DC(DS, Ftmp).

Following this, the control plan determining device 3 determines a control plan corresponding to the need V(DS, Stime) being processed (Step S1-3 in FIG. 5). The control plan determining device 3 uses the control plan that is currently applied to the air-conditioning equipment 6 at that point in time (hereinafter termed the “existing control plan”), the control plans set in advance in the control plan storage device 4, and the need status DC(DS, Ftmp) that is held in the need identifying device 5, to determine the new control plan to be applied to the air-conditioning equipment 6.

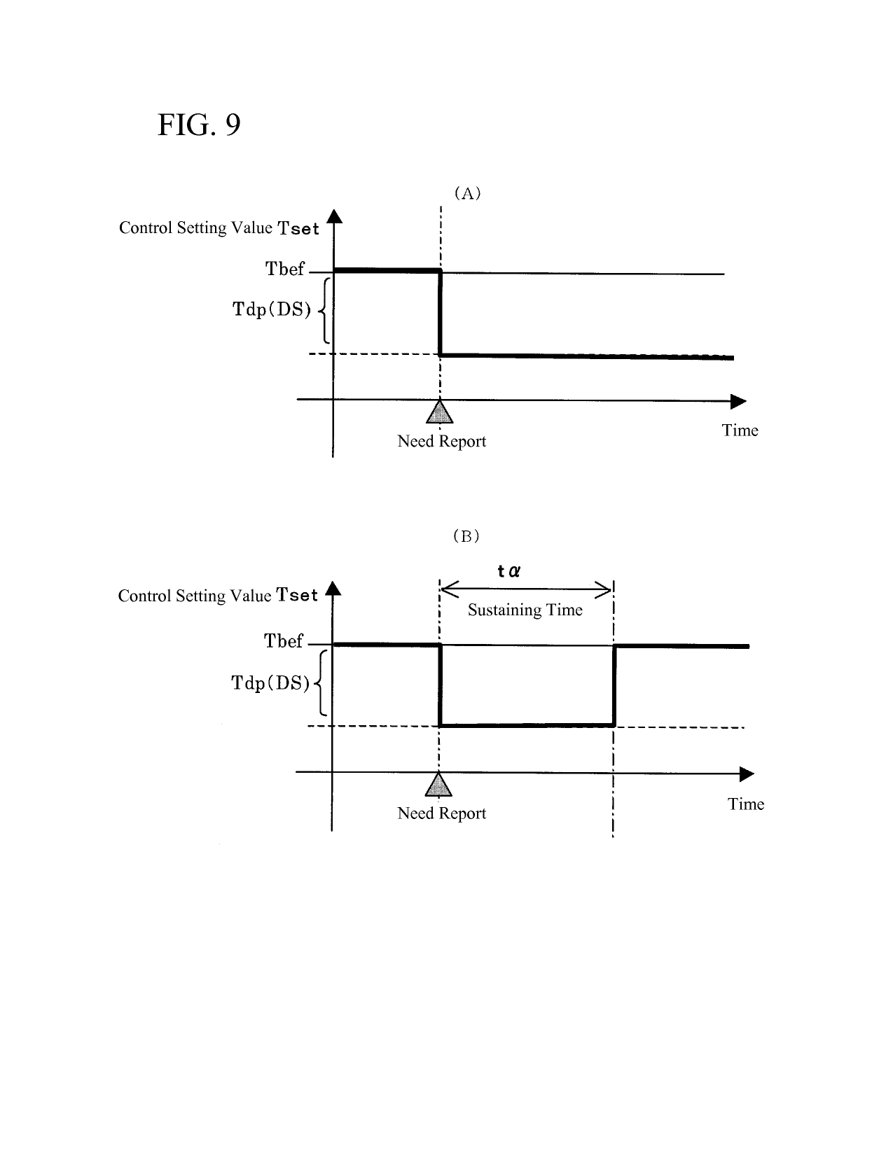

Control plans corresponding to temporary needs and to persistent needs are each set up in advance in the control plan storage device 4. Conventional general-use control plans (conventional control plans that are executed in accordance with the change category, without identifying the persistence category) may be established as the control plans corresponding to persistent needs (control plans corresponding to Ftmp=0). For simplicity in the explanation, in the example, a control plan wherein the control setting value Tset=Tbef at the point in time of processing the need V(DS, Stime) is changed depending on the change category DS of the need V(DS, Stime), as illustrated in FIG. 9(A) is used as the control plan corresponding to a persistent need. The change in the control setting value Tset through this control plan can be expressed by the following expression:

Tset=Tbef+Tdp(DS) (2)

The temperature setting value is an example of a control setting value Tset. The Tdp(DS) in Expression (2) is the magnitude of the change in the setting value. This setting value change magnitude Tdp(DS) is determined by the following equation:

Tdp(DS)=S(DS)×γdp(DS) (3)

As described above, when the occupant reports “Hot,” the change category DS will be set to 1, and when the occupant reports “Cold,” the change category DS will be set to −1. The S(DS) in Expression (3) is a coefficient indicating the direction of the change (increase vs. decrease) in the control setting value Tset corresponding to the change category DS. When the change category DS=1, the coefficient S(1)=−1, and when the change category DS=−1, the coefficient S(−1)=1. In other words, when the occupant reports “Hot,” the coefficient S(DS) is set to −1, and the control setting value Tset is lowered, and if the occupant reports “Cold,” then the coefficient S(DS) is set to 1, and the control setting value Tset is increased.

The γdp(DS) in Expression (3) is the setting value change magnitude corresponding to the change category DS. This setting value change magnitude γdp(DS) is determined in advance by the control contractor, the facilities manager, or the like, depending on the change category DS. Here the setting value change magnitude γdp(DS) is defined uniformly as 0.5° C. regardless of the value of the change category DS, but, of course, it may instead be given values that vary depending on the value of the change category DS.

On the other hand, a control plan wherein, for example, the control setting value Tset is changed in the same way as for the control plan corresponding to a persistent need but then, after the change in the setting value has been sustained for a sustaining time tα, the control setting value Tset is returned to Tset=Tbef from before responding to the reported need, may be set up as a control plan corresponding to a temporary need (a control plan corresponding to Ftmp=1) (FIG. 9(B)). The changes in the control setting value Tset are as have been explained using Expression (2) and Expression (3). The sustaining time tα is the time for a sudden change in the metabolic rate of the occupant to approach stability, and may be set to, for example, 20 minutes, or the like, depending on the corresponding occupant activity. This sustaining time tα may be adjusted by the facilities manager, or the like, depending on operating conditions. Note that in this example the restoration of Tset to Tbef may, of course, be such that it gradually approaches Tbef over a restoration interval that is set in advance. Moreover, the sustaining time tα and the restoring interval may instead be modified depending on the inferred occupant activity corresponding to the time band number (referencing the supplemental information in FIG. 8).

Finally, the equipment controlling device 2 controls the air-conditioning equipment 6 based on the new control planned that has been determined by the control plan determining device 3 (Step S1-4 in FIG. 5). That is, the equipment controlling device 2 sets the new control setting value Tset to be applied to the air-conditioning equipment 6 based on the current control setting value Tset=Tbef that is applied to the air-conditioning equipment 6 at the point in time of processing the need V(DS, Stime), the change category DS of the need V(DS, Stime), and the control plan determined by the control plan determining device 3. Moreover, the equipment controlling device 2 controls of the air-conditioning equipment 6 so that the controlled quantity of the air conditioner (for example, the room temperature) will match the control setting value Tset (for example, a room temperature setting value). PID, for example, is well known as a control algorithm.

The processes in Step S1-1 through S1-4 are repeated for the need each time the occupant issues a new need report.

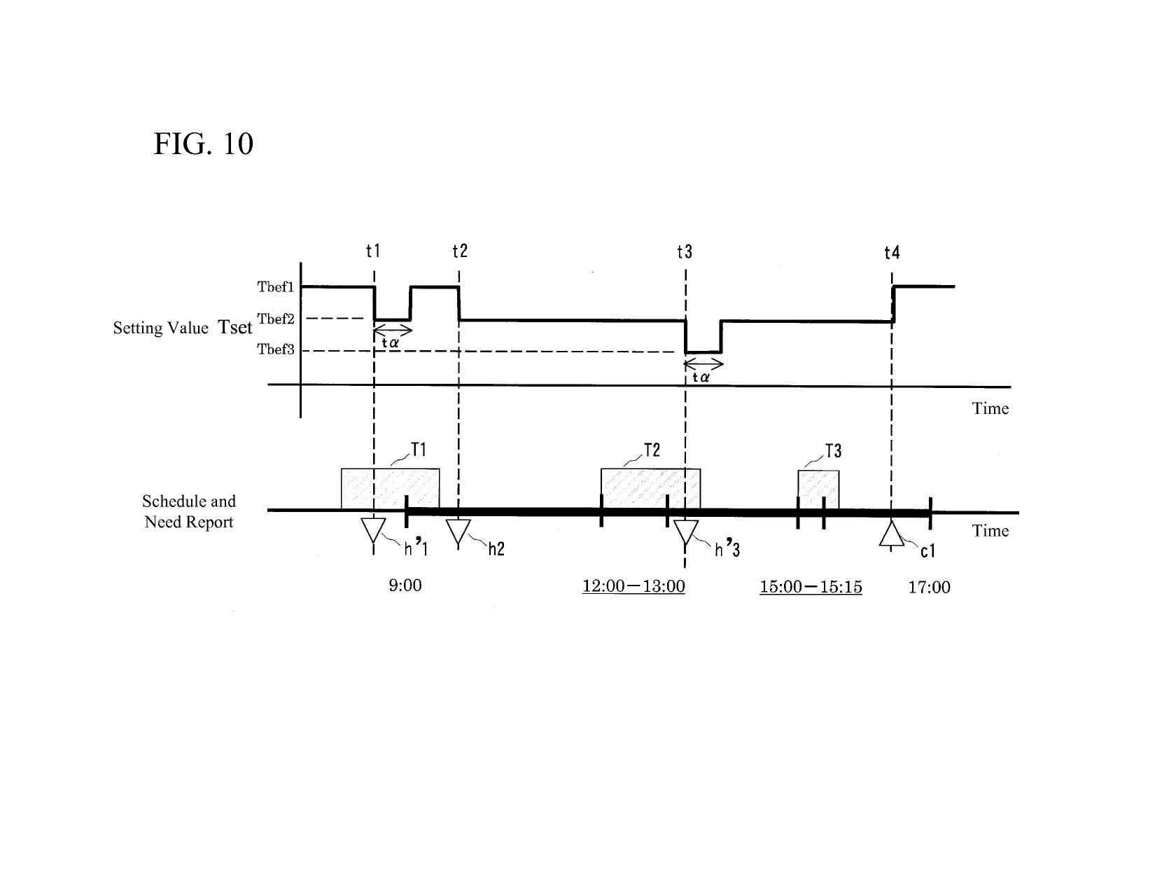

FIG. 10 illustrates one example of how the control setting value Tset is changed in response to a need report. In the example in FIG. 10 as well, the workplace schedule and the temporary need identifying time bands T1 through T3 are set as illustrated in FIG. 6 and FIG. 7. In FIG. 10, h′1 and h′3 indicate “Hot” temporary needs, h2 indicates a “Hot” persistent need, and c1 indicates a “Cold” persistent need.

When, at a time tl, the “Hot” temporary need h′1 is produced, the control plan determining device 3 determines a control plan for responding to a temporary need as the new control plan to be applied to the air-conditioning equipment 6. The equipment controlling device 2, based on this control plan, reduces the control setting value Tset to Tbef2 in accordance with Expression (2) and Expression (3), and then, after the sustaining time tα (which is 30 minutes in the example), restores the control setting value Tset to Tbef1 from before time t1.

Next, at a time t2, the “Hot” persistent need h2 is produced, the control plan determining device 3 determines a control plan for responding to a persistent need as the new control plan to be applied to the air-conditioning equipment 6. The equipment controlling device 2, based on this control plan, reduces the control setting value Tset to Tbef2 in accordance with Expression (2) and Expression (3).

Following this, at a time t3, the “Hot” temporary need h′3 is produced, the control plan determining device 3 determines a control plan for responding to a temporary need as the new control plan to be applied to the air-conditioning equipment 6. The equipment controlling device 2, based on this control plan, reduces the control setting value Tset to Tbef3, and then, after the sustaining time ta, restores the control setting value Tset to Tbef2 from before time t3.

Next, at a time t4, the “Cold” persistent need c1 is produced, the control plan determining device 3 determines a control plan for responding to a persistent need as the new control plan to be applied to the air-conditioning equipment 6. The equipment controlling device 2, based on this control plan, increases the control setting value Tset to Tbef1.

As described above, in the example, identifying the persistence category of the need and applying, to the air-conditioning equipment 6, a control plan that is based on the result of identifying the persistence category enables a reduction in the likelihood of destabilization of control while reducing the number of reports by the occupant and reducing the burden on the occupant in reporting work.

Moreover, because, in the example, the association between time bands and persistence categories is established at the point in time of establishing the workplace schedule, the facilities manager or energy manager can easily forecast and control in advance the state of operations, the amount of energy consumed, and the like, by comparing actual results with days in the past that operated on the same schedule.

Moreover, while there were two categories, “Hot” and “Cold,” for the change categories for the needs in the example, instead there may be, for example, five different change categories: “Hot,” “Somewhat hot,” “Neither hot nor cold,” “Somewhat cold,” and “Cold.” In this case, for “Hot,” DS=1, for “Somewhat hot,” DS=2, for “Neither hot nor cold,” DS=3, for “Somewhat cold,” DS=4, and for “Cold,” DS=5. The coefficients S(DS) corresponding to the change categories DS=1, 2, 3, 4, and 5 are set, respectively, to −1, −1, 0, 1, and 1. Moreover, the setting value change magnitudes ydp(DS) corresponding to these change categories DS=1, 2, 3, 4, and 5 are set, respectively, to 1.0° C., 0.5° C., 0° C., 0.3° C., and 0.6° C. In this way, the setting value change magnitude γdp(DS) may differ depending on the change category DS.

Moreover, while, for ease in the explanation, an example of a temporary need identification table based on a classical single-day workplace schedule was given in the example, more preferably different schedules should be applied depending on events throughout the year and depending on the day of the week. In such a case, a temporary need identifying table would be produced through adding dates and weekday information as appropriate, and adding the date information and weekday information to the report time Stime of the need V(DS, Stime), corresponding thereto.

Moreover, while an example of control that responds to the individual needs at the times at which need reports are produced was presented in the example, this can of course be applied also to performing periodic control at, for example, 15 minute intervals. In this case, the need identifying device 5 would maintain the needs V(DS, Stime) from the occupants temporarily in a database, and perform, with each control period, general processes such as a last-highest priority process that uses, as the representative need, only the most recent need within the period, a high-frequency occurrence process that uses, as the representative need, only the need that has occurred most often from among the plurality of needs that have been produced during the 15-minute period, a need ratio process that infers the representative need based on the ratios of the numbers of needs, relative to all of the needs, that have been produced during the 15-minute period (referencing Japanese Unexamined Patent Application Publication 2006-214624), or the like, to determine a need that is representative of the applicable period (hereinafter termed the “representative need”), and determine the change category DS of that representative need, while defining, as the report time Stime of the representative need, the time, for example, at which the change category DS was determined. Given this, the need identifying device 5 may perform the processes in Step S1-2 through S1-4 in FIG. 5 for the representative need.

Moreover, while an example wherein a single air-conditioned area and a single occupant corresponded to a single need identification-type air-conditioning controlling device 1 was explained in the example, this can, of course, also be applied similarly to cases wherein there is a plurality of occupants. When applying the periodic control execution set forth above to a case wherein there is a plurality of occupants, information for specifying the need informant (the ID (identification) of the need informant, location information for the need informant, or the like) may also be added to the need V(DS, Stime), if necessary in establishing the representative need.

Moreover, when a single need identification-type air-conditioning controlling device 1 controls a plurality of air-conditioning equipment 6, the need inputting terminal 7 adds, to the need V, target equipment specifying information able to specify the air-conditioning equipment 6 that will be subject to the control (information such as an air-conditioning equipment ID, an air-conditioned area ID, a need informant ID, need informant location information, or the like, able to specify the air-conditioning equipment 6 that will be subjected to control) and sent to the need identification-type air-conditioning controlling device 1. The control plan determining device 3 of the need identification-type air-conditioning controlling device 1 may determine the control plan for the air-conditioning equipment 6 that is subject to control depending on the target equipment specifying information, and the equipment controlling device 2 may specify and control the air-conditioning equipment 6 that is to be the subject of the control based on this target equipment specifying information. Note that in this case control plans may be set up in advance in the control plan storage device 4 for each individual air-conditioning equipment 6.

Moreover, in the case of, for example, an air-conditioning controlling system for centralized control of air-conditioning of a plurality of workplaces, for example, in a tenant building with centralized control, a plurality of applicable workplace schedules may be used, and information able to specify the workplaces, along with temporary need identification tables corresponding to each of the individual workplaces may be stored in the DEMS, and the facilities manager may input the change needs (“Hot,” “Cold,” “Increase by XX° C.,” and “Decrease by XX° C.,” and the like), together with the workplace specifying information.

### Another Example

Another example according to the present invention will be explained next. In this example, identification of whether or not a need is a temporary need is made, based on identification rules derived in advance, from the personal schedule of the informant and on the timing with which the need is reported, and the air-conditioning controlling plan is determined based on the identification result.

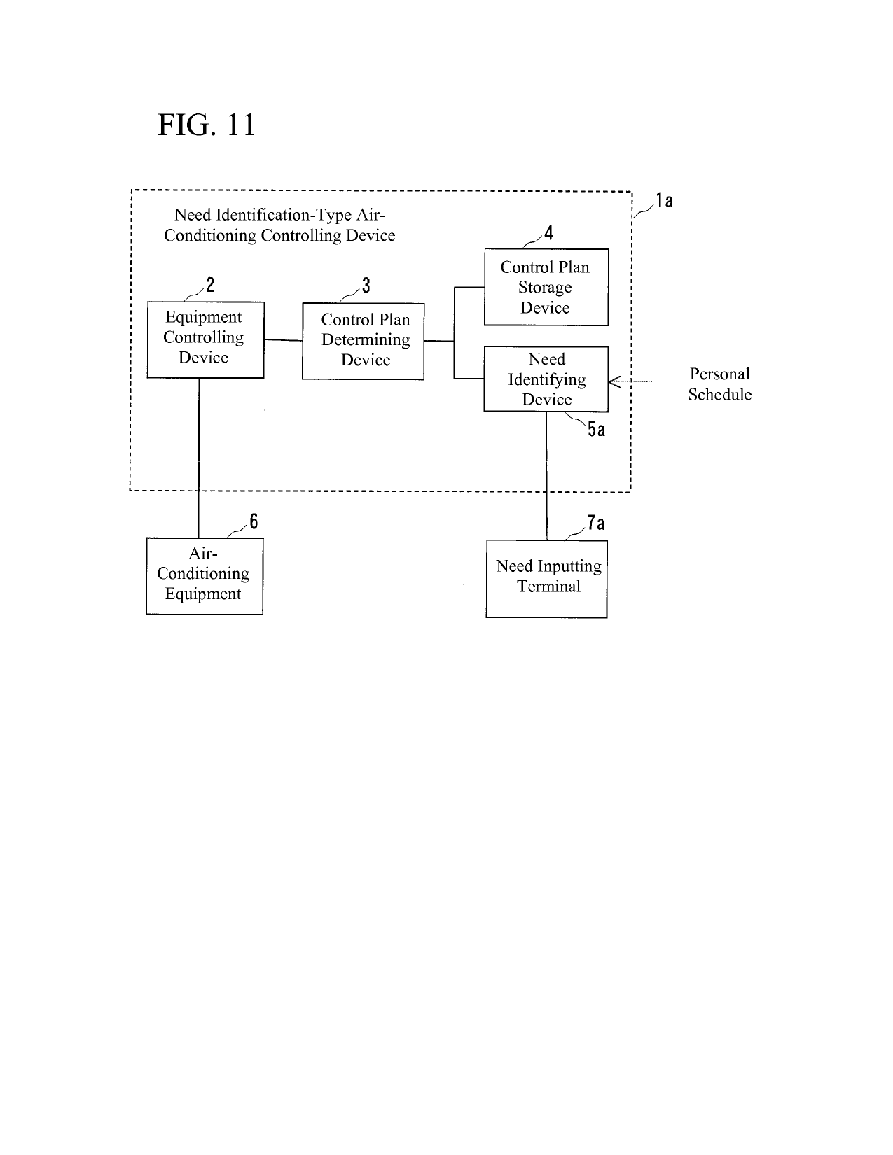

FIG. 11 is a block diagram illustrating the structure of a need identification-type air-conditioning controlling device according to the another example, where structures identical to those in FIG. 3 are assigned identical codes. The need identification-type air-conditioning controlling device 1a in the another example is provided with an equipment controlling device 2, a control plan determining device 3, a control plan storage device 4, and a need identifying device 5a.

The structure of the need identifying device 5a is identical to that of the need identifying device 5 in the example with the exception of the point that a personal schedule is used instead of the workplace schedule, and thus the codes of FIG. 4 will be used to explain the operation of the need identifying device 5a.

Moreover, because the process flow in the need identification-type air-conditioning controlling device 1a is identical to that in the example, FIG. 5 will be used to explain the operation of the need identification-type air-conditioning controlling device 1a.

In the another example, which uses the personal schedule, the need inputting terminal 7a sends, to the need identifying device 5a, the change category DS for the need inputted by a need informant, the report time Stime thereof, and a need informant ID (hereinafter termed “UID”). The need inputting unit 50 of the need identifying device 5a stores, as a need V′(DS, Stime, UID), the information that has been received (Step S1-1 in FIG. 5). As explained in the example, the report time Stime need not necessarily be sent from the need inputting terminal 7a, but instead the report time Stime may be added by the need inputting unit 50 using, for the report time, the time at which the need report is received.

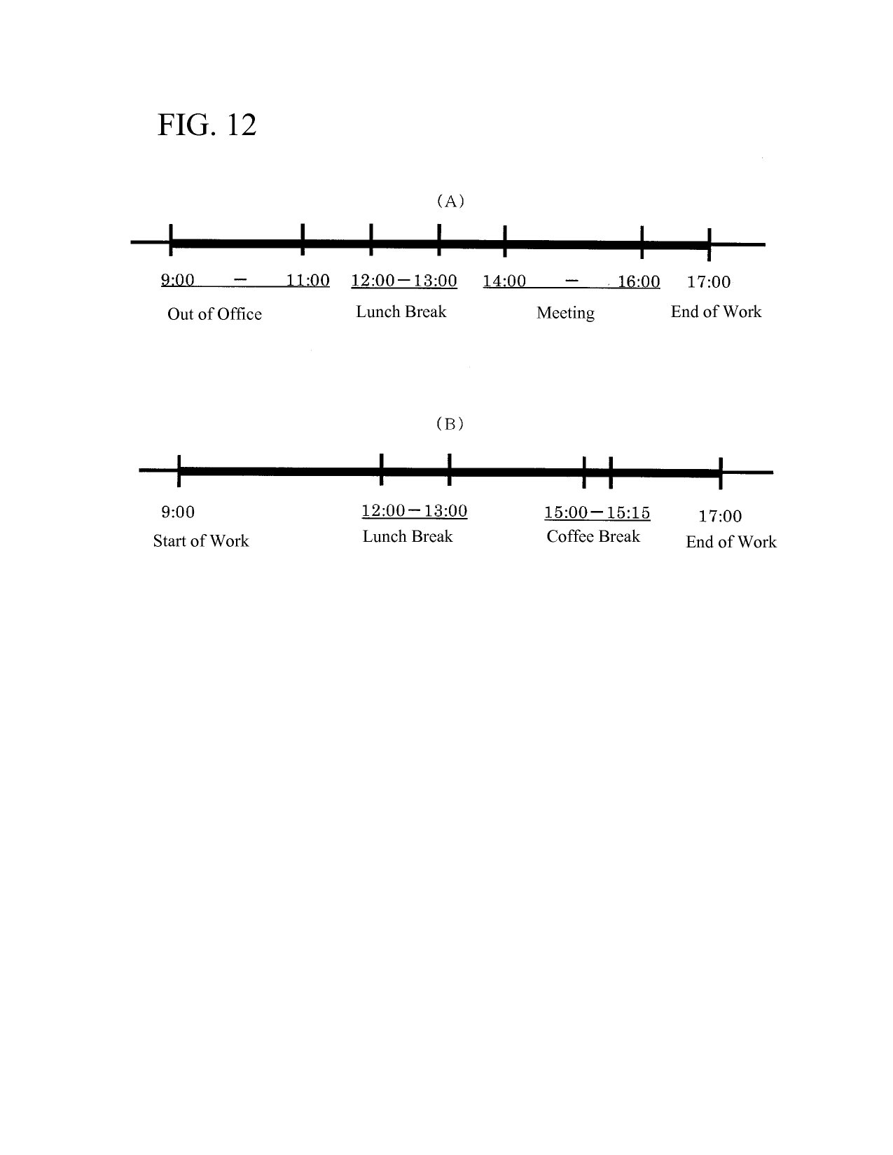

An example schedule for a given day for occupants A and B that occupy the workplace described in the example and that share an air-conditioned area are illustrated in FIG. 12(A) and FIG. 12(B). FIG. 12(A) presents a personal schedule for the occupant A, and FIG. 12(B) presents a personal schedule for the occupant B. In the example in FIG. 12(A), occupant A is out of the office between the hours of 9:00 AM and 11:00 AM, takes a lunch break from 12:00 noon until 1:00 PM, has a meeting from 2:00 PM through 4:00 PM, and finishes work at 5:00 PM. In the example in FIG. 12(B), work hours are from 9:00 AM to 5:00 PM. There is a lunch break from 12:00 noon to 1:00 PM, and a coffee break from 3:00 PM to 3:15 PM. Because many offices have implemented scheduler systems for employee schedule control, the use, in identifying the persistence categories of needs, of the personal schedules that are recorded in the scheduler system makes it possible to increase the reliability of the persistence category identification without prompting the informant to input new information.

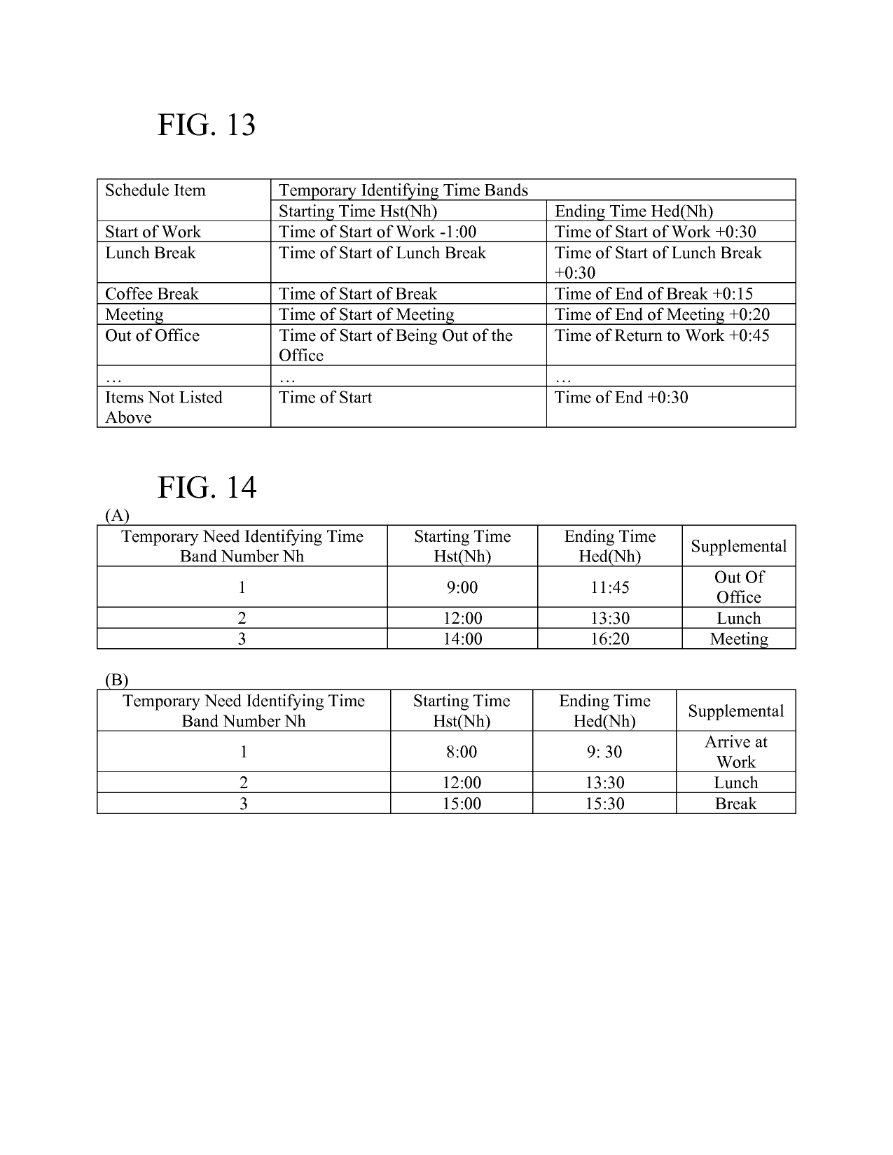

The rules for setting up temporary need identifying time bands corresponding to the schedule items of “Start of work,” “Lunch break,” “Coffee break,” “Meeting,” “and “Out of office” are established in advance in the identification rule deriving unit 52 of the need identifying device 5a by the control contractor, the facilities manager, and the energy manager. FIG. 13 shows an example of rules for setting up the temporary need identifying time bands.

According to FIG. 13, the starting time Hst(Nh) of a temporary need identifying time band corresponding to the start of work is the time that is one hour prior to the time for the start of work, and the ending time Hed(Nh) is the time that is 30 minutes after the time of the start of work. The starting time Hst(Nh) for the temporary need identifying time band corresponding to the lunch break is the starting time for the lunch break, and the ending time Hed(Nh) is the time that is 30 minutes after the lunch break starting time. The starting time Hst(Nh) of the temporary need identifying time band corresponding to a break time is the starting time for the break, and the ending time Hed(Nh) is the time that is 15 minutes after the ending time for the break. The starting time Hst(Nh) for the temporary need identifying time band corresponding to a meeting is the starting time of the meeting, and the ending time Hed(Nh) is the time that is 20 minutes after the ending time for the meeting. The starting time Hst(Nh) for the temporary need identifying time band corresponding to being out of the office is the starting time for being out, and the ending time Hed(Nh) is the time that is 45 minutes after the time of the return to work.

In the another example, the identification rule deriving unit 52 of the need identifying device 5a references the personal schedule of each individual occupant early each morning to generate a temporary need identification table for each individual occupant based on the setting rules as illustrated in FIG. 13, and stores, into the identification rule storage unit 53, the temporary need identification tables that have been generated, associated with the IDs of the occupants. Conversely, the personal schedule of the informant may be referenced when a need report is received, and the setting rules shown in FIG. 13 may be used to perform identification of the persistence category of the need. Note that the informant ID is information that identifies the association between the occupant and the schedule information, for example, an employee ID or an individual extension number, or the like.

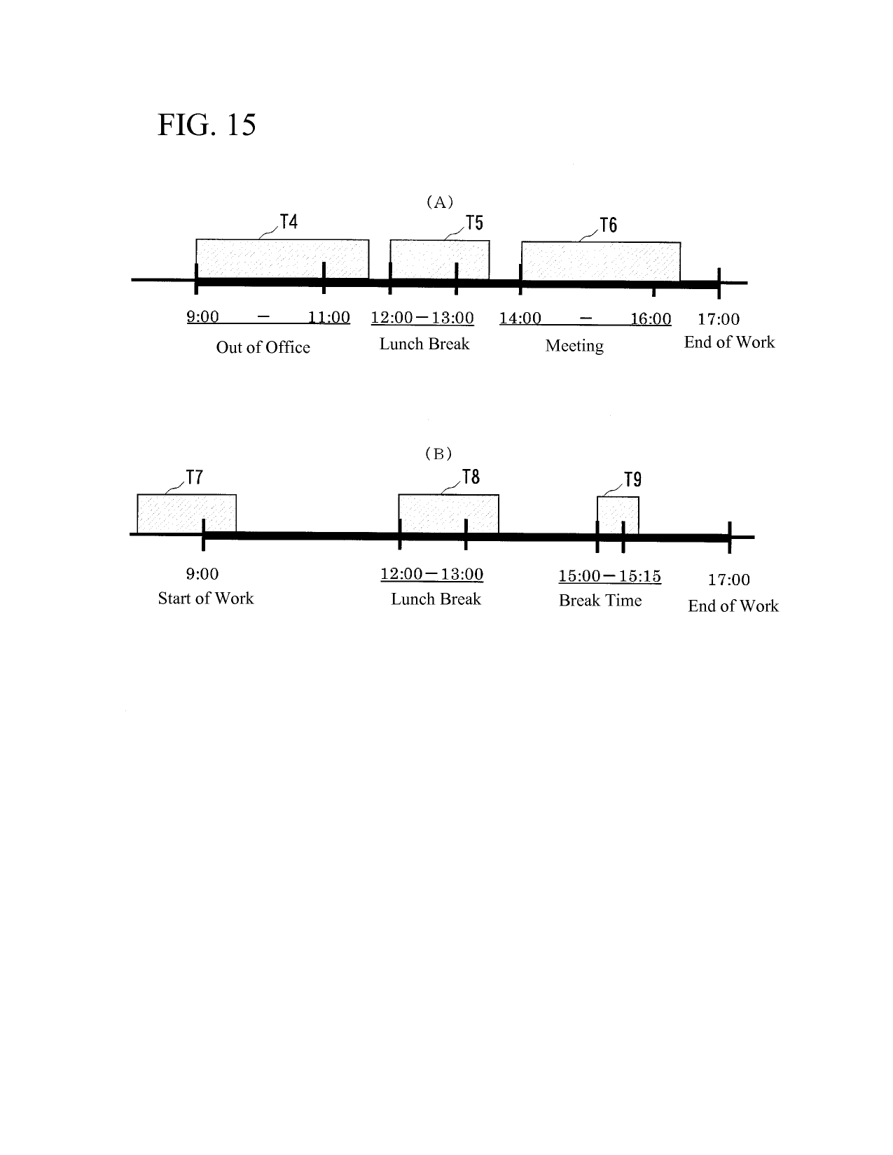

Examples of temporary need identification tables for the occupants A and B, generated by the identification rule deriving unit 52 based on the setting rules shown in FIG. 13 are shown, respectively, in FIG. 14(A) and FIG. 14(B). FIG. 15(A) is a diagram illustrating the time bands wherein reported needs from the occupant A will be recognized as temporary needs, and FIG. 15(B) is a diagram illustrating the time bands wherein reported needs from the occupant B will be recognized as temporary needs. For the case of the occupant A, there are three time bands T4 through T6 wherein a reported need will be viewed as a temporary need, where the time band T4 is the interval from 9:00 AM through 11:45 AM, the time band T5 is the interval from 12:00 noon through 1:30 PM, and the time band T6 is the interval from 2:00 PM through 4:20 PM. In the case of occupant B, there are three time bands T7 through T9 for recognizing reported needs as temporary needs, where time band T7 is the interval from 8:00 AM to 9:30 AM, time band T8 is the interval from 12:00 noon to 1:30 PM, and time band T9 is the interval from 3:00 PM to 3:30 PM.

Note that while a case wherein the temporary need identification tables were generated from the personal schedules has been explained in the another example, the temporary need identification tables may, of course, be generated from the workplace schedule in the same way.

The identification processing unit 51 of the need identifying device 5a, upon receipt of a need V′(DS, Stime, UID) from the need inputting terminal 7a, references the temporary need identification table corresponding to the UID, to perform identification of the persistence category of the reported need (Step S1-2 in FIG. 5). Aside from the point that a temporary need identification table that is associated with the need informant is used, this persistence category identification process is identical to that in the example, so detailed explanations thereof will be omitted.

The identification processing unit 51 associates the change category DS and the identification flag Ftmp with the need V′(DS, Stime, UID), and stores these as the need status DC(DS, Ftmp). Note that if the workplace schedule, such as the start of work, the lunch break, and the like, are not established in the personal schedules, then the temporary need identification table based on the workplace schedule, shown in the example, and a temporary need identification table based on the personal schedule may be referenced.

The operation of the control plan determining device 3 (Step S1-3 in FIG. 5) and the operation of the equipment controlling device 2 (Step S1-4 in FIG. 5) were explained in the example, so explanations thereof are omitted here.

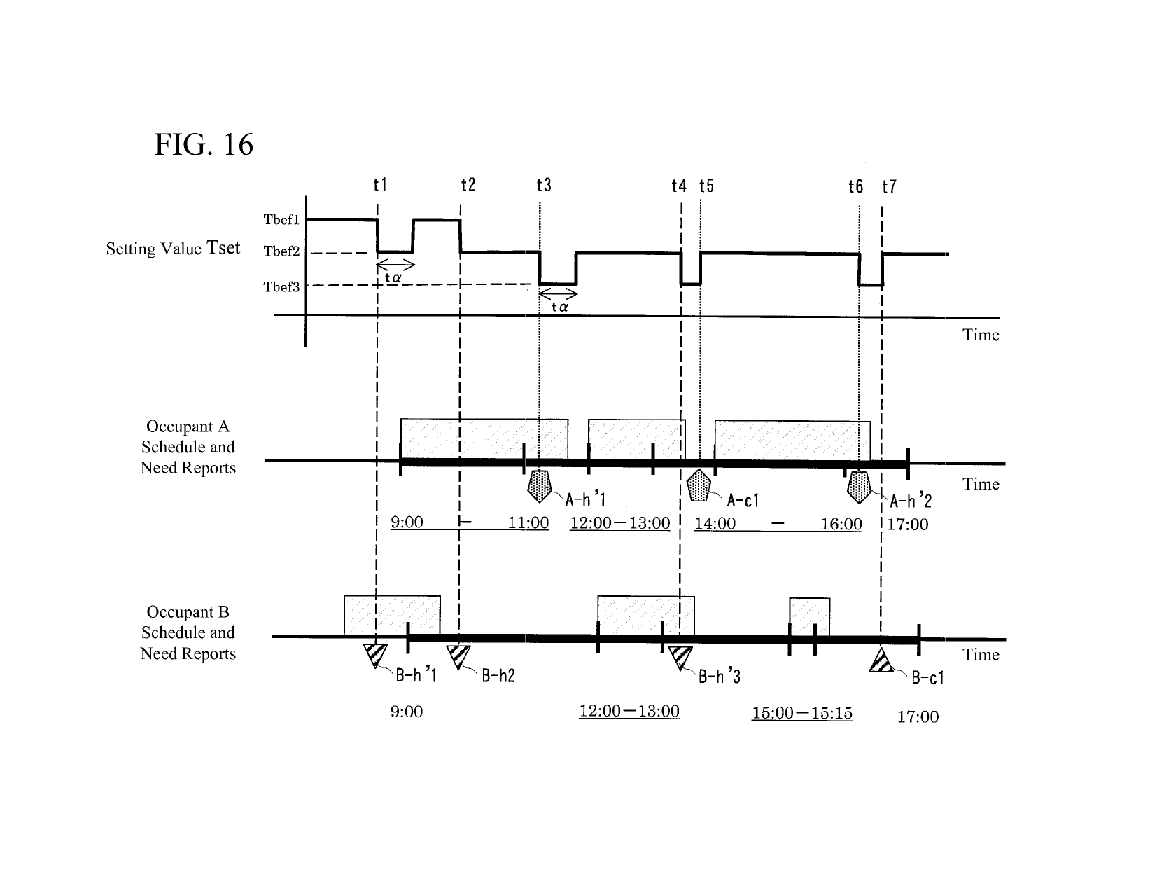

FIG. 16 illustrates one example of how the control setting value Tset is changed in response to need reports from the occupants A and B. In the example in FIG. 16 as well, the personal schedules and the temporary need identifying time bands T4 through T9 are set as shown in FIG. 12(A), FIG. 12(B), FIG. 15(A), and FIG. 15(B). In FIG. 16, A-h′1 and A-h′2 represent “Hot” temporary needs from occupant A, A-c1 represents a “Cold” persistent need from occupant A, B-h′1 and B-h′3 represent “Hot” temporary needs from occupant B, B-h2 represents a “Hot” persistent need from occupant B, and B-cl represents a “Cold” persistent need from occupant B.

When, at a time tl, the “Hot” temporary need B-h′l is produced from occupant B, the control plan determining device 3 determines a control plan for responding to a temporary need as the new control plan to be applied to the air-conditioning equipment 6. The equipment controlling device 2, based on this control plan, reduces the control setting value Tset to Tbef2 in accordance with Expression (2) and Expression (3), and then, after the sustaining time tα (which is 30 minutes in the another example), restores the control setting value Tset to Tbef1 from before time t1.

Next, at a time t2, the “Hot” persistent need B-h2 is produced from occupant B, the control plan determining device 3 determines a control plan for responding to a persistent need as the new control plan to be applied to the air-conditioning equipment 6. The equipment controlling device 2, based on this control plan, reduces the control setting value Tset to Tbef2 in accordance with Expression (2) and Expression (3).

Following this, at a time t3, the “Hot” temporary need A-h′1 is produced from occupant A, the control plan determining device 3 determines a control plan for responding to a temporary need as the new control plan to be applied to the air-conditioning equipment 6. The equipment controlling device 2, based on this control plan, reduces the control setting value Tset to Tbef3, and then, after the sustaining time ta, restores the control setting value Tset to Tbef2 from before time t3.

Following this, at a time t4, the “Hot” temporary need B-h′3 is produced from occupant B, the control plan determining device 3 determines a control plan for responding to a temporary need as the new control plan to be applied to the air-conditioning equipment 6. The equipment controlling device 2, based on this control plan, decreases the control setting value Tset to Tbef3. Although here the state wherein the control setting value Tset=Tbef3 would be sustained for the sustaining time tα, there is a “Cold” temporary need A-c1 from occupant A at time t5 prior to the sustaining time tα elapsing, and so the control plan determining device 3 determines a control plan corresponding to the temporary need as the new control plan to be applied to the air-conditioning equipment 6. The equipment controlling device 2, based on this control plan, increases the control setting value Tset to Tbef2.

Following this, at a time t6, the “Hot” temporary need A-h′2 is produced from occupant A, the control plan determining device 3 determines a control plan for responding to a temporary need as the new control plan to be applied to the air-conditioning equipment 6. The equipment controlling device 2, based on this control plan, decreases the control setting value Tset to Tbef3. Although here the state wherein the control setting value Tset=Tbef3 would be sustained for the sustaining time tα, there is a “Cold” temporary need B-c1 from occupant B at time t7 prior to the sustaining time tα elapsing, and so the control plan determining device 3 determines a control plan corresponding to the temporary need as the new control plan to be applied to the air-conditioning equipment 6. The equipment controlling device 2, based on this control plan, increases the control setting value Tset to Tbef2.

As described above, when, in the another example, a temporary need and a persistent need are in competition, the control plan determining device 3 followed a last-highest priority policy wherein the most recent need is given priority; however, instead the priority may be given to the need in the direction that relaxes the setting value to the low-energy side, as a policy that gives priority to energy conservation. The policies regarding whether to use the temporary need or the persistent need, the method for determining the need change category to be applied to air-conditioning control, and the method for determining the persistence category may be established as appropriate.

In this way, identifying the persistence category of the need and applying, to the air-conditioning equipment 6, a control plan based on the result of identifying the persistence category, in the another example, is able to reduce the likelihood of destabilization of control while reducing the burden on the informants of need reporting.

Note that, as explained in the example, the another example can, of course, also be applied to control wherein needs from informants are handled on a periodic basis. Moreover, as explained in the example, the another example may be applied also to cases wherein there is a plurality of occupants. Furthermore, the another example can, of course, be applied also to cases wherein a need identification-type air-conditioning controlling device 1 a controls a plurality of air-conditioning equipment 6.

The need identification-type air-conditioning controlling devices 1 and la explained in the example and the another example may be embodied through a computer that is provided with a CPU, a storage device, and an interface, and through a program for controlling these hardware resources. The CPU follows a program stored in the storage device to execute the processes explained in the example and the another example.

The present invention can be applied to technologies for reflecting, into air-conditioning control, needs pertaining to air-conditioning from informants.

Obviously, numerous modifications and variations of the present invention are possible in light of the above teachings. It is therefore to be understood that within the scope of the appended claims, the invention may be practiced otherwise than as specifically described herein.

1. A need identifying device comprising:
an inputting unit that receives from an informant a need pertaining to air-conditioning; and
a need identifying unit that identifies whether the need from the informant is a temporary need or a persistent need, based on information pertaining to an activity that changes a metabolic rate of the informant, the need identifying unit includes
an identification rule storage unit that stores an identification rule derived in advance from information pertaining to activities that change the metabolic rate of the informant, and
an identification processing unit that identifies whether the need from the informant is the temporary need or the persistent need, based on a time at which the need from the informant was produced, and based on the identification rule,
an identification rule deriving unit that derives the identification rule from the information pertaining to the activity that changes the metabolic rate of the informant and from a specific setting rule.

2. The need identifying device as set forth in claim 1, wherein
the information pertaining to the activity that changes the metabolic rate of the informant is a schedule pertaining to the informant, and
the need identifying unit performs identification periodically using only a representative need, based on a plurality of needs produced during a period of a constant length.

3. The need identifying device as set forth in claim 1, wherein
the information pertaining to the activity that changes the metabolic rate of the informant is a workplace schedule for a workplace to which the informant belongs.

4. The need identifying device as set forth in claim 1, wherein
the information pertaining to the activity that changes the metabolic rate of the informant is a personal schedule.

5. The need identifying device as set forth in claim 1, wherein
the information pertaining to the activity that changes the metabolic rate of the informant is a workplace schedule for a workplace to which the informant belongs and a personal schedule of the informant.

6. An air-conditioning controlling system comprising:
a need identifying device including
an inputting unit that receives from an informant a need pertaining to air-conditioning, and
a need identifying unit that identifies whether the need from the informant is a temporary need or a persistent need, based on information pertaining to an activity that changes a metabolic rate of the informant;
a control plan storage device that stores, in advance, respectively for temporary needs and for persistent needs, control plans wherein rules for changing control setting values for air-conditioning in accordance with needs from the informant are established;
a control plan determining device that determines a control plan, from the control plans stored in the control plan storage device, the control plan corresponding to an identification result of the need identifying device, and being applied to an air-conditioning equipment; and
an equipment controlling device that controls the air-conditioning equipment based on the control plan determined by the control plan determining device, wherein
the control plan corresponding to the temporary need is a control plan that establishes that a control setting value is changed in accordance with the need from the informant, and that the control setting value is returned to a value from prior to the change, after a specific sustaining time has elapsed, and
the control plan corresponding to the persistent need is a control plan that establishes that the control setting value is changed on a persistent basis in accordance with the need from the informant.

7. The air-conditioning controlling system as set forth in claim 6, wherein
the control plan determining device determines a control plan specifying, from a plurality of air-conditioning equipments, an air-conditioning equipment that is to be subjected to control, based on target-equipment specifying information added to the need from the informant,
the equipment controlling device controls the air-conditioning equipment that is to be subjected to control based on the control plan determined by the control plan determining device, and
when there is a competition between the temporary need and the persistent need, the control plan determining device follows a policy that has been established in advance to use either the temporary need or the persistent need, and apply, to the air-conditioning equipment, the control plan corresponding to the need that is used.

8. A need identifying method comprising:
an inputting step for receiving from an informant a need pertaining to air-conditioning; and
a need identifying step for identifying whether the need from the informant is a temporary need or a persistent need, based on information pertaining to an activity that changes a metabolic rate of the informant, the need identifying step includes
an identifying step for identifying whether the need from the informant is a temporary need or a persistent need, based on information an identification rule derived in advance pertaining to the activity that changes the metabolic rate of the informant, and based on a time at which the need was produced from the informant, and
an identification rule deriving step for deriving the identification rule from information pertaining to the activity that changes the metabolic rate of the informant and from a specific setting rule.

9. The need identifying method as set forth in claim 8, wherein
the information pertaining to the activity that changes the metabolic rate of the informant is a schedule pertaining to the informant.

10. An air-conditioning controlling method comprising:
an inputting step for receiving from an informant a need pertaining to air-conditioning;
a need identifying step for identifying whether the need from the informant is a temporary need or a persistent need, based on information pertaining to an activity that changes a metabolic rate of the informant;
a control plan determining step for determining, from control plans stored in a control plan storage device, a control plan corresponding to an identification result of the need identifying step, as a control plan to be applied to an air-conditioning equipment by referencing the control plan storage device that stores, in advance, respectively for temporary needs and for persistent needs, the control plans wherein rules for changing control setting values for air-conditioning in accordance with the need from the informant are established; and
an equipment controlling step for controlling the air-conditioning equipment based on the control plan determined by the control plan determining step, wherein
the control plan corresponding to the temporary need is a control plan that establishes that a control setting value is changed in accordance with the need from the informant, and that the control setting value is returned to a value from prior to the change, after a specific sustaining time has elapsed, and
the control plan corresponding to the persistent need is a control plan that establishes that the control setting value is changed on a persistent basis in accordance with the need from the informant.
